(19) United States
(12) Patent Application Publication
(10) Pub. No.: US 2025/0111221 A1
(43) Pub. Date: Apr. 3, 2025

(54) MACHINE LEARNING MODEL SELECTION

(71) Applicant: NCR Voyix Corporation, Atlanta, GA (US)

(72) Inventors: Somboon Supakkul, Atlanta, GA (US); Ching Hong Mak, Atlanta, GA (US)

(21) Appl. No.: 18/375,326

(22) Filed: Sep. 29, 2023

(51) Int. Cl. G06N 3/08

(52) U.S. Cl. CPC G06N 3/08

(57) ABSTRACT

Forecasting models are tested for accuracy metrics on a plurality of historical data sets for a plurality of businesses. An optimal forecasting model is determined for each business's historical data set. A forecasting selection or recommendation model is trained on each business's historical data set to predict the corresponding optimal forecasting model. When a given business desires an updated forecast, a most recent historical data set is obtained and provided as input to the recommendation model. The recommendation model returns as output a predicted optimal forecasting model. The optimal forecasting model is processed with the most recent historical data set to obtain a forecast and the forecast is provided to the business.

### BACKGROUND

Machine learning for time series forecasting is time consuming and computer resource intensive. This is because a substantial amount of time and computer resources are needed to find the best machine learning model (model) for a given set of data with a given set of characteristics. Many models are available for selection, the challenge and effort are finding the best model for a given set of data characteristics. For example, there can be thousands of payment processing merchants in different cities, each merchant has different business data characteristics associated with their customer demographics, business location weather patterns, etc.

Conventionally, each business's data is processed through each of the available models and the accuracy metrics produced by each available model is inspected. The best model, per business, is selected based on the accuracy metrics and the best model, per business, is processed to provide forecast predictions for the corresponding business. This process repeats, for each business, each time a next forecast is needed.

### SUMMARY

In various embodiments, methods, and a system for machine learning model (“model) selection are presented. According to an embodiment, a single recommendation model is trained on a plurality of business data sets associated with a plurality of businesses. During training, the business's data sets are tested against each available forecasting model. Accuracy metrics for each business's data set are calculated based on the corresponding available forecasting model's predicted forecast. The data sets and a forecasting model associated with the highest accuracy metrics for each business are used to train the recommendation model to predict an optimal forecasting model when provided a given data set for a given business. Once trained, the recommendation model predicts an optical forecasting model to obtain a current forecast from based on inherent data characteristics in a given business's current data set. As data characteristics change over time for a business, the recommendation model changes its predicted optimal forecasting model accordingly.

### BRIEF DESCRIPTION OF THE DRAWINGS

FIG. 1A is a diagram of a system for machine learning model (“model) selection, according to an example embodiment.

FIG. 1B is a diagram of a process flow for training and processing a model for model selection and forecasting, according to an example embodiment.

FIG. 2 is a flow diagram of method for selecting a model for forecasting, according to an example embodiment.

FIG. 3 is a flow diagram of another method for selecting a model for forecasting, according to an example embodiment.

### DETAILED DESCRIPTION

Time series forecasting is a common machine learning model (“model”) technique for predicting future chronological events, such as business sales or demands. For organizations that deal with data sets with the same characteristics, such as sales data of retail stores with similar business factors or geography, they can use the same forecasting technique. However, for large organizations that may need to provide forecasting for thousands of stores or locations with different business factors, demographics, and weather, using the same forecasting model is not likely to produce accurate forecasts for all the stores and locations. Finding an optimal forecasting model for each business's data set within a large organization is time consuming, requires experimentation with different forecasting models, and consumes a significant amount of computing resources.

Typically, a large organization experiments by processing multiple different forecasting models against each business's data set. The accuracy metrics are evaluated and the model with the best accuracy metrics is selected for a corresponding business to provide its forecasting data. This manual approach is time consuming and difficult to scale for a large number of data sets associated with a large number of businesses of an organization. Consequently, the approach is not performed as frequently as it should be for the organization's businesses because each business's data characteristics can change over time such that what was an optimal model for a business can become a suboptimal for that business over time.

Most sales organizations need to anticipate further sales so that they can order supplies for product manufacturing or order products to stock their inventories in advance. A large sales organization has many stores in different cities, states, or countries. If a sales organization were to choose one forecasting model for all stores, this is unlikely to produce optimal forecasts for all of the organization's stores due to each store having different sales impact factors, such as locations, customer bases, and weather. However, manually testing the accuracy for each business's data against available forecasting models to select each business's optimal forecasting model is a large manually undertaking, which consume a significant amount of human and computing resources of the organization. Thus, the organization is unlikely to perform this exercise frequently, which means the business' forecasts can quickly become of no value to the organization.

These issues are resolved with the teachings provided herein. A single recommendation model is trained to perform optimal forecasting model selection. As an initial part of the training, each of the available forecasting models is tested against each of the available business' data sets. The output from each of available forecasting model is used to construct a training data set for training the recommendation model.

The accuracy metrics are evaluated to select the best performing available forecast model for each business's data set. A two-dimensional 2D set of data from each business data set is assembled and a training record is generated. There is one training record per business. Each record includes a pointer to a corresponding 2D set of data associated with a corresponding business's data set, and an identifier for an optimal forecast model for the corresponding business's data set. The optimal forecast model is determined from the accuracy metrics obtained from the available forecasting models during a testing portion of the training. The recommendation model is trained on the records to use the 2D sets of data as input and produce as output an identifier for the optimal forecasting model (which is included in the training record so that the recommendation model can configure itself based on characteristics in the 2D sets of data to predict the optimal forecasting model). As data characteristics change for a given business's data set, the recommendation model changes accordingly and identifies a current optimal forecast model.

Once trained, the recommendation model is released to production, historical time series data sets for any given business are normalized into the 2D sets of data and provided as input and the recommendation model returns as output an optimal forecasting model for each business. There is no need to manually test each of the available forecasting models when a new set of time series forecasting predictions are needed, as is the case with conventional approaches.

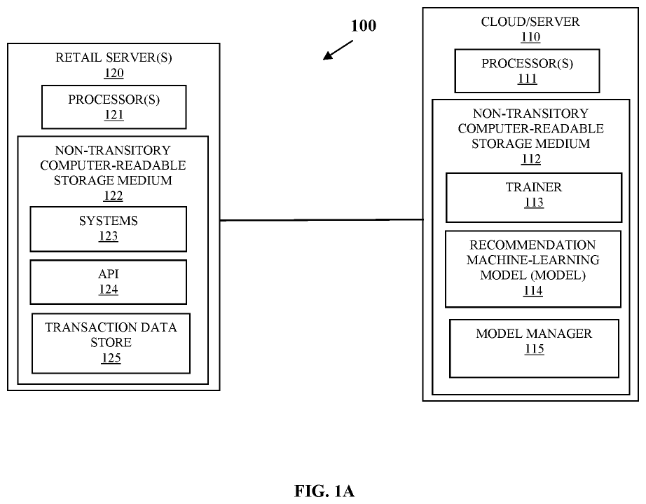

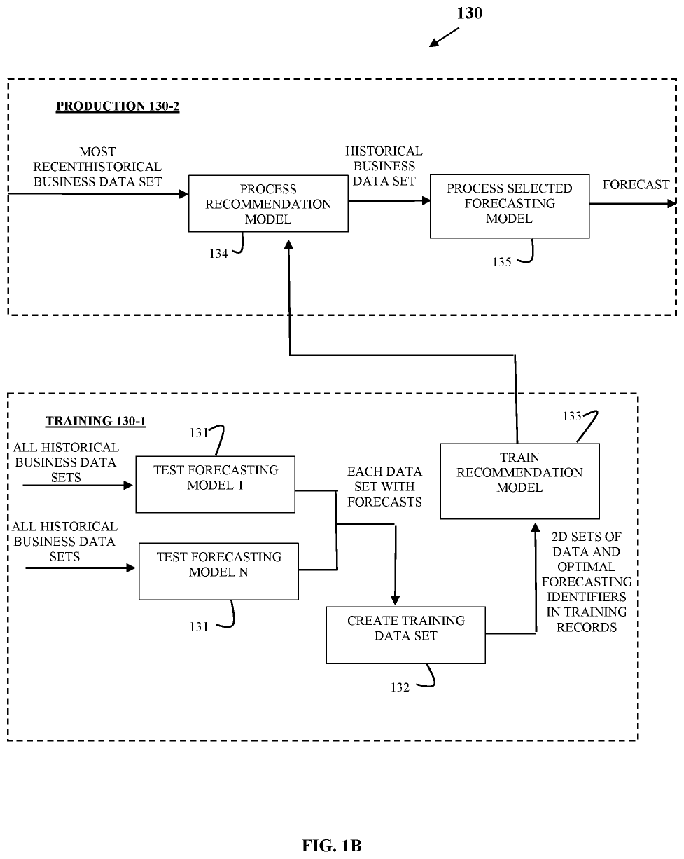

FIG. 1A is a diagram of a system 100 for model selection, according to an example embodiment. System 100 is shown in simplified form with just those components necessary for comprehending the teachings provided herein illustrated. Notably, more, or fewer components are foreseeable without departing from the teachings herein.

System 100 includes a cloud/server 110 (herein after just “cloud 110”) and a plurality of retail servers 120. Cloud 110 includes at least one processor 111 and a non-transitory computer-readable storage medium (herein after just “medium”) 112 which includes instructions for a trainer 113, a recommendation model 114, and a model manager 115. The instructions when executed by the processor 111, cause processor 111 to perform operations discussed herein and below with respect to 113-115.

Each retail server includes at least one processor 121 and medium 122, which includes instructions for systems 123, application programming interface (API) 124, and a transaction data store. The instructions when executed by processor 121, cause processor 121 to perform operations discussed herein and below with respect to 123 and 124. Notably, transaction data store 125 is also available to systems 123 and API 124 via medium 122.

In preparation for training of recommendation model 114, each business's historical time series data sets that is used for obtaining forecasts from a forecasting model is tested by providing the historical time series data as input to each of the forecast models. Each forecast model produces a forecast for each business based on the corresponding business's historical time series data set. Since the data sets are historical, the actual sales associated with the forecasts are obtained from the historical data sets and compared against the sales predictions in the forecasts. Trainer 113 computes accuracy metrics for each forecast associated with each business as provided by each forecasting model.

Trainer 113 assembles a training data set to train recommendation model 114. Each record in the training data set includes a normalized 2D set of data for a given business historical data set and a forecasting model identifier for the forecasting model determined to have the best record. Each business is associated with a single training record, and the total number of training records is equal to the total number of historical data sets, one per business.

Trainer 113 trains the recommendation model 114 on the training data set to produce as output, for each historical data set, a forecasting model identifier that corresponds to a forecasting model with the highest accuracy metrics. For example, if there are 10 available forecasting models to select from, a given business has 1 record in the training data set, and the trainer 113 trains the recommendation model 114 to produce as output the forecasting identifier for the forecasting model that produced the best accuracy metrics for that business's historical data set.

Once the recommendation model 114 is trained, it is released to production for management by model manager 115. Model manager 115 obtains a given business's updated or most-recent historical data set from a corresponding transaction data store 125 of a given retailer server 120 using API 124 when a new time series forecast is required by the given business, The model manager 115 provides the most-recent and updated historical data set normalized into the 2D set of data to recommendation model 114 as input and receives as output a forecasting model identifier for an optimal forecasting model that is predicted to provide the best accuracy metrics for the forecast needed. Model manager 115 provides the most recent and updated historical data set normalized into the 2D set of data for the given business to the forecasting model as input and uses API 124 to provide the outputted forecast produced by forecasting model to one or more systems 123 of a retailer associated with the request for an updated forecast.

In an embodiment, a given retailer or a given business of a given retailer does not have to request an updated forecast; rather, model manager 115 is configured to provide updated forecasts at configured intervals of time. For example, model manager 115 obtains the most recent historical data set for business X, processes recommendation model 114 with the normalized 2D set of data for the most recent historical data, processes an optimal forecasting model identified by recommendation model 114, and provides an updated forecast produced from the forecasting model on a daily basis, weekly basis, monthly basis, or quarterly basis.

In an embodiment, model manager 115 processes and provides updated forecasts at a configured interval of time and provides an updated forecast on demand and whenever requested by a given retailer or a given business of a given retailer. Thus, the model manager 115 provides updated forecasts through a pull and on demand approach and/or through a push approach at configural intervals of time.

FIG. 1B is a diagram of a process flow 130 for training and processing a model for model selection and forecasting, according to an example embodiment. The process flow 130 is segmented into a training process flow 130-1 and a production process flow 130-2.

In the training process flow 130-1, each historical data set of each business is tested by testing each available forecasting model at 131. In an embodiment, trainer 113 obtains the historical data sets from each of the businesses via corresponding APIs 124 and corresponding transaction data stores 125. Trainer 113 provides each historical data set from each business as input to each of the available forecasting models. Notably, all historical data sets are provided to each available forecasting model. Each forecasting model produces a forecast for each historical data set. Each forecast is a time series set of predicted sales produced by a corresponding forecasting model based on the corresponding historical data set.

At 132, Trainer 113 uses each historical data sets' actual observed sales within the corresponding historical data set and compares that against the corresponding forecast. This allows trainer 113 to calculate accuracy metrics for each historical data set and for each forecasting model.

At 132, trainer 113 creates a training data set for training recommendation model 114. The training data set includes a link or a pointer to a normalized set of data for each historical training data sets and optimal forecasting model identifiers in records. There is one record per business.

At 132, trainer 113 normalizes the historical data sets into the 2D sets of data. The set of data includes rows representing a first time series interval, for example a week, a month, an hour, etc. and columns representing a second and different time series interval, such as days of a week, weeks of a month, or hour of a day. Each cell in a given 2D set of data includes the actual historical sales data for a given business's data set that corresponds to intersection of the row and column. For example, a 2D set of data with rows representing weeks and the columns representing days of the week, the actual sales of a given business are included in the cells that correspond to a given week and a given day of the given week. In an embodiment, the total number of columns in any given 2D set of data is determined by applicable seasonality.

At 132, trainer 113 further calculates the accuracy metrics observed for each business based on the forecasts predicted by the available forecasting models during testing. The highest accuracy metrics are associated with the optimal forecasting models.

At 132, trainer 113 generates training records for training the recommendation model 114. Each record corresponds to a given business and that business's historical data set. Each record includes a pointer or link to the normalized 2D set of data and an optimal forecasting model identifier, which was determined to have the highest accuracy metrics from the testing, at 131.

At 133, trainer 113 provides the records to train recommendation model 114 to produce as output an optimal forecasting model identifier when provided a given normalized 2D set of data for a given business's historical data set.

Trainer 113 sets aside a configured portions of the records to use for training at 133 and to uses a testing at 133. In an embodiment, 70 percent of the total records are used for training and 30 percent of the remaining records are used for testing an accuracy rate of recommendation model 114. In an embodiment 80 percent of the total records are used for training and 20 percent of the remaining records are used for testing an accuracy rate of recommendation model 114.

In an embodiment, trainer 113 creates the recommendation model 114 using a supervised learning classifier model that learns the best forecasting model for different 2D time series sets of data. In an embodiment, trainer 113 uses a 2D convolutional neural network (CNN) deep learning algorithm to train recommendation model 114 to learn from the 2D set of data.

Once a configured level of accuracy metrics are obtained during training by trainer 113, the recommendation model, at 134, is released to production for management by model manager 115. During production, when a forecast is needed (e.g., on demand request or at a configured interval of time), model manager 115 obtains the most recent historical data set for a given requesting business is obtained from the corresponding transaction data store 125. Model manager 115 normalizes the historical data set into the 2D set of data, discussed above. In an embodiment, model manager 115 provides the historical data set to trainer 113 and trainer 113 returns the normalized 2D set of data.

At 134, model manager 115 provides the normalized 2D set of data as input to recommendation model 114 and receives as output a forecasting model identifier for a forecasting model predicted to provide optimal accuracy metrics based on inherent characteristics of the provided data. At 135, model manager 115 provides the original historical data set for the requesting business as input to the selected and optimal forecasting model. The optimal forecasting model produces a forecast, which model manager 115 provides to one or more systems 123 via API 124.

In an embodiment, the forecasts, provided by the forecasting models, are sales predicted to occur at a preconfigured interval of time over a future period of time. For example, a given sales forecast for a next month includes predicted sales expected to occur on each day of the next month. Notably, the interval of time and the length of the future period of time are configurable parameters processed by the forecasting models.

In an embodiment, the forecasts, provided by the forecasting models, are predicted inventory levels of products. In an embodiment, the forecasts, provided by the forecasting models, are predicted viewers of content media. Notably, other types of forecast different from what has been mentioned benefits from the teachings provided herein.

One now appreciates how a recommendation model 114 is trained and generated for purposes of selecting an optimal forecasting model based on the actual historical data itself and its inherent characteristics. This ensures that businesses are relying on optimal and accurate forecasts even as business conditions change for the businesses because the conditions are detected in their data and based on their data recommendation model 114 selects current optimal forecasting models to provide their forecasts.

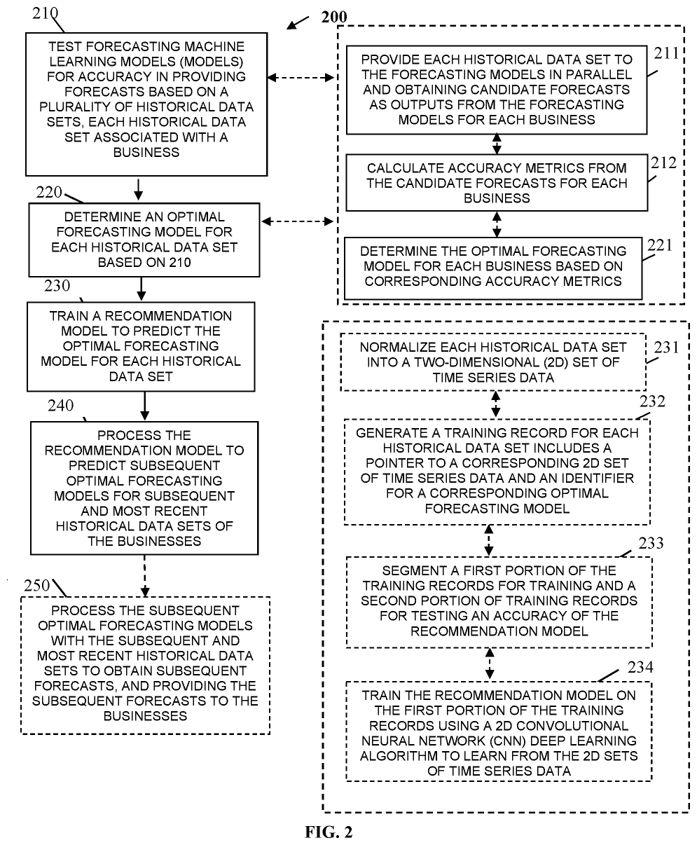

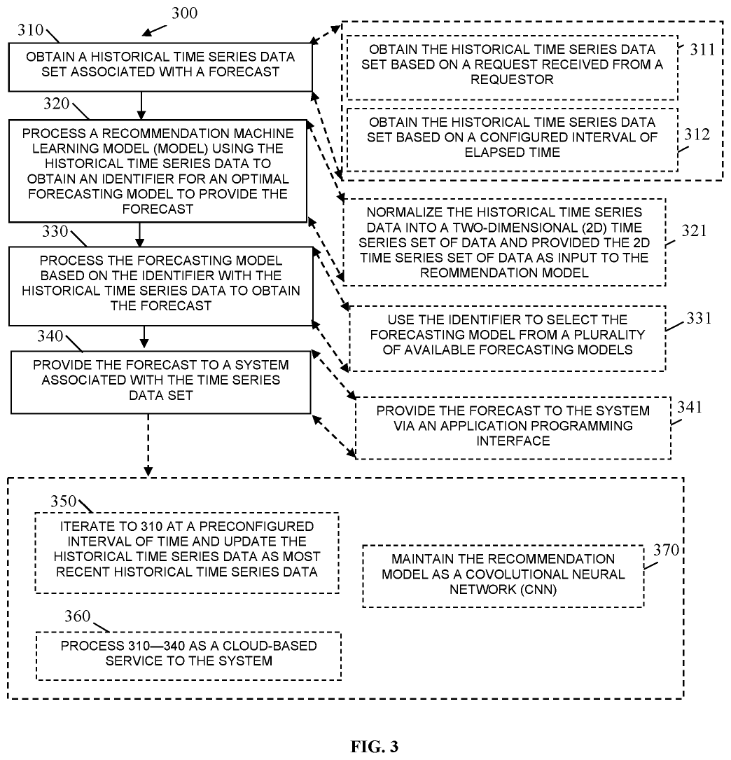

The above-referenced embodiments and other embodiments are now discussed with reference to FIGS. 2 and 3. FIG. 2 is a flow diagram of method 200 for selecting a model for forecasting, according to an example embodiment. The software module(s) that implements the method 200 is referred to as an “optimal forecasting model selector.” The optimal forecasting model selector is implemented as executable instructions programmed and residing within memory and/or a non-transitory computer-readable (processor-readable) storage medium and executed by a plurality of hardware processors of a plurality of hardware computing devices. The processors of the devices that execute the optimal forecasting model selector are specifically configured and programmed to process the optimal forecasting model selector. The optimal forecasting model selector has access to one or more networks during its processing. The networks can be wired, wireless, or a combination of wired and wireless.

In an embodiment, the devices that execute the optimal forecasting model selector is cloud 110 and/or server 110. In an embodiment, the optimal forecasting model selector is all or some combination of 113, 114, 115, and/or process flow 130.

At 210, the optimal forecasting model selector tests forecasting models for accuracy in providing forecasts based on a plurality of historical data sets. Each unique historical data set is associated with a business or a subject.

In an embodiment, at 211, the optimal forecasting model selector provides each historical data set to the forecasting models in parallel and obtains candidate forecasts as output from the forecasting models for each business. For example, if there are 2 business and 10 forecasting models, the optimal forecasting model selector provides the historical data sets associated with both the first business and the second business to each of the 10 forecasting models in parallel. This results in a total of 20 forecasts, 2 forecasts, one for each business, from each of the 10 forecasting models.

In an embodiment of 211 and at 212, the optimal forecasting model selector calculates accuracy metrics from the candidate forecasts for each business. For example, the forecasts are for a time period which already exists in the historical data sets, such that the predicted forecasts are compared against what is actually in the historical data sets for the time period in order to calculate the accuracy metrics for each of the forecasts.

At 220, the optimal forecasting model selector determines an optimal forecasting model for each historical data set based on the testing. In an embodiment of 220 and 212, at 221, the optimal forecasting model selector determines the optimal forecasting model for each business based on corresponding accuracy metrics. For example, if a business's historical data resulted in a first forecast with first accuracy metrics that are higher than a second forecast with second accuracy metrics, then the optimal forecast is the first forecast; the forecast with the highest accuracy metrics.

At 230, the optimal forecasting model selector uses trainer 113 to train a recommendation model 114 to predict the optimal forecasting model for each unique historical data set. In an embodiment, at 231, the optimal forecasting model selector normalizes each historical data set into a 2D set of time series data.

In an embodiment of 231 and at 232, the optimal forecasting model selector generates a training record for each unique historical data set. The data set includes a pointer to a corresponding 2D set of time series data and an identifier for a corresponding optimal forecasting model.

In an embodiment of 232, and at 233, the optimal forecasting model selector segments a first portion of the training records for training the recommendation model 114 and a second portion of the training records for testing an accuracy of the recommendation model 114 after training. In an embodiment of 233 and at 234, the optimal forecasting model selector uses trainer 113 and trains the recommendation model 114 on the first portion of the training records using a 2D CNN deep learning algorithm to lean from the 2D sets of time series data. Thus, predictions of the recommendation model 114 are based on inherent data characteristics of the original historical data sets.

At 240, the optimal forecasting model selector processes the recommendation model 114 to predict subsequent optimal forecasting models for subsequent and most recent historical data sets of the businesses. In an embodiment, at 250, the optimal forecasting model selector processes the subsequent optimal forecasting models with the subsequent and most recent historical data sets to obtain subsequent forecasts. The optimal forecasting model selector provides the subsequent forecasts to the businesses or to systems 123 of the businesses.

FIG. 3 is a flow diagram of another method 300 for selecting a model for forecasting, according to an example embodiment. The software module(s) that implements the method 300 is referred to as a “model selection manager.” The model selection manager is implemented as executable instructions programmed and residing within memory and/or a non-transitory computer-readable (processor-readable) storage medium and executed by one or more hardware processors of one or more hardware devices. The processors of the devices that execute the model selection manager are specifically configured and programmed to process the model selection manager. The model selection manager has access to one or more networks during its processing. The networks can be wired, wireless, or a combination of wired and wireless.

The model selection manager presents another and, in some ways, enhanced processing perspective of that which was described above with the method 200 and process flow 130. In an embodiment, cloud 110 executes the model selection manager. In an embodiment, server 110 executes the model selection manager. In an embodiment, the model selection manager is all or some combination of 113, 114, 115, process flow 130, and/or method 200.

At 310, the model selection manager obtains a historical time series data set associated with a forecast. In an embodiment, at 311, the model selection manager obtains the historical time series data set based on a request received from a requestor. In an embodiment, at 312, the model selection manager obtains the historical time series data set based on a configured interval of elapsed time; for example, daily, weekly, monthly, quarterly, etc.

At 320, the model selection manager processes a recommendation model 114 using the historical time series data to obtain an identifier for an optimal forecasting model to provide the forecast. In an embodiment, at 321, the model selection manager normalizes the historical time series data into a 2D time series set of data. The model selection manager provides the 2D time series set of data as input to the recommendation model 114 to receive the identifier as a predicted optimal forecasting model as output from the recommendation model 114.

At 330, the model selection manager processes the forecasting model based on the identifier with the historical time series data to obtain the forecast. In an embodiment, at 331, the model selection manager uses the identifier to select the forecasting model from a plurality of available forecasting models.

At 340, the model selection manager provides the forecast to a system 123 associated with the time series data set. In an embodiment, at 341, the model selection manager provides the forecast to the system 123 via an API 124.

In an embodiment, at 350, the model selection manager iterates to 310 at a preconfigured interval of time. The model selection manager updates the historical time series data as most recent historical time series data and performs 320-340 using the most recent historical time series data.

In an embodiment, at 360, the model selection manager processes as a cloud-based service accessible to the system 123. The system uses API 124 to request new forecasts on demand and/or to receive forecasts at preconfigured intervals of time.

In an embodiment, the model selection manager maintains the recommendation model 114 as a CNN model. In an embodiment, the CNN is used as a supervised learning trainer.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
testing forecasting machine learning models (models) for accuracy in providing forecasts based on a plurality of historical data sets, each historical data set associated with a business;
determining an optimal forecasting model for each historical data set based on the testing;
training a recommendation model to predict the optimal forecasting model for each historical data set; and
processing the recommendation model to predict subsequent optimal forecasting models for subsequent and most recent historical data sets of the businesses.

2. The method of claim 1 further comprising, processing the subsequent optimal forecasting models with the subsequent and most recent historical data sets to obtain subsequent forecasts, and providing the subsequent forecasts to the businesses.

3. The method of claim 1, wherein testing further includes providing each historical data set to the forecasting models in parallel and obtaining candidate forecasts as outputs from the forecasting models for each business.

4. The method of claim 3, wherein testing further includes calculating accuracy metrics from the candidate forecasts of each business.

5. The method of claim 4, wherein determining further includes determining the optimal forecasting model for each business based on corresponding accuracy metrics.

6. The method of claim 1, wherein training further includes normalizing each historical data set into a two-dimensional (2D) set of time series data.

7. The method of claim 6, wherein normalizing further includes generating a training record for each historical data set comprising a pointer to a corresponding 2D set of time series data and an identifier for a corresponding optimal forecasting model.

8. The method of claim 7, wherein generating further includes segmenting a first portion of the training records for training and a second portion of training records for testing an accuracy of the recommendation model.

9. The method of claim 8, wherein training further includes training the recommendation model on the first portion of the training records using a 2D convolutional neural network (CNN) deep learning algorithm to learn from the 2D sets of time series data.

10. A method, comprising:
obtaining a historical time series data set associated with a forecast;
processing a recommendation machine learning model (model) using the historical time series data to obtain an identifier for an optimal forecasting model to provide the forecast;
processing the forecasting model based on the identifier with the historical time series data to obtain the forecast; and
provide the forecast to a system associated with the historical time series data set.

11. The method of claim 10, wherein obtaining further includes obtaining the historical time series data set based on a request received from a requestor.

12. The method of claim 10, wherein obtaining further includes obtaining the historical time series data set based on a configured interval of elapsed time.

13. The method of claim 10, wherein processing the recommendation model further includes normalizing the historical time series data into a two-dimensional (2D) time series data set of data and providing the 2D time series set of data as input to the recommendation model.

14. The method of claim 10, wherein processing the forecasting model further includes using the identifier to select the forecasting model from a plurality of available forecasting models.

15. The method of claim 10, wherein providing further includes providing the forecast to the system via an application programming interface.

16. The method of claim 10 further comprising:
iterating to the obtaining at a preconfigured interval of time and updating the historical time series data as most recent historical time series data.

17. The method of claim 10 further comprising:
processing the method as a cloud-based service to the system.

18. The method of claim 10 further comprising:
maintaining the recommendation model as a convolutional neural network (CNN) model.

19. A system comprising:
a cloud comprising a plurality of servers;
each server comprising at least one processor and a non-transitory computer-readable storage medium;
each non-transitory computer-readable storage medium comprising executable instructions;
the executable instructions when provided to or obtained by a corresponding processor cause the corresponding processor to perform operations, comprising:
training a recommendation machine learning model (model) to provide a predicted optimal forecasting model based on characteristics in a historical data set used as input to a plurality of available forecasting models;
obtaining a most recent historical data set associated with a request to obtain a forecast;
processing the recommendation model using the most recent historical data set and obtaining a currently predicted optimal forecasting model as output from the recommendation model;
processing the currently predicted optimal forecasting model using the most recent historical data set and obtaining a current forecast as output from the currently predicted optimal forecasting model; and
providing the current forecast.

20. The system of claim 19, wherein the forecast is a sales forecast for a business and provides sales for the business predicted at a configured interval of time over a future period of time.
